(19) United States
(12) Patent Application Publication
(10) Pub. No.: US 2017/0183467 A1
(43) Pub. Date: Jun. 29, 2017

(54) ENHANCED BARRIER FILMS COMBINING VAPOR DEPOSITED COATINGS AND POLYMER BASED COATINGS

(71) Applicant: NANOPACK, INC., Wayne, PA (US)

(72) Inventor: Howard S. KRAVITZ, Wayne, PA (US)

(21) Appl. No.: 15/301,979

(22) PCT Filed: Apr. 10, 2015
(86) PCT No.: PCT/US15/25234

§ 371 Date: Oct. 5, 2016

Related U.S. Application Data
(60) Provisional application No. 61/977,921, filed on Apr. 10, 2014.
(60) Provisional application No. 62/053,895, filed on Sep. 23, 2014.

(51) Int. Cl. C08J 7/04; B05D 5/00; C09D 129/04; B05D 7/00

(52) U.S. Cl. CPC C08J 7/045; B05D 7/54; B05D 5/00; C09D 129/04; C08J 2367/02; C08J 2429/04; C08J 2475/04

(57) ABSTRACT

The invention concerns barrier films comprising: (i) a substrate comprising at least first and second coatings on the substrate; (ii) the first coating comprising an inorganic oxide, metal oxide or metallic coating; and (iii) the second coating capable of adhering to the substrates, wherein the second coating is polymeric; wherein the degradation of oxygen transmission rate is reduced when compared to a barrier film without the second coating when the barrier film is subjected to Gelbo-type flexing as described in ASTM F392.

### RELATED APPLICATIONS

This application claims benefit of U.S. Patent Application No. 61/977,921, filed Apr. 10, 2014 and U.S. Patent Application No. 62/053,895, filed Sep. 23, 2014. The disclosures of each are incorporated herein by reference.

### TECHNICAL FIELD

The invention concerns barrier coated films having a combination of vapor deposited coating and polymer based coatings.

### BACKGROUND

Barrier coated flexible films are useful in a number of industries to retard the ingress and egress of various gases and vapors, notably oxygen and water. These gases and vapors cause foods to degrade. For example, oxygen permeation into a bag of peanuts causes the oxidation of oils, which turn rancid. And water permeation into a bag of potato chips causes the chips to become soggy.

Various coatings are commonly used, notably polyvinylidene chloride (“Saran”), which has a major share of the worldwide barrier coating market. Additionally, certain polymers are also known for their barrier properties; some are used in solid form and some may be solvated and applied as a coating onto flexible films. Ethylene vinyl alcohol (EVOH) is commonly co-extruded together with polyethylene (PE) into a multi-layered film structure of PE/EVOH/PE, which is then laminated to polyethylene terephthalate (polyester or PET) flexible films. This laminated PET/EVOH co-extruded structure is ready to be formed into a bag or pouch. Similarly, polyvinyl alcohol (PVOH) resin can be solvated in water and be applied as a coating onto flexible films such as biaxially oriented polypropylene (BOPP), PET. PE, and the like. Heavier coatings of PVOH are also applied to polypropylene extruded sheet and then pulled or tentered to a much thinner thickness—the common process of biaxially orienting the film for enhanced physical properties. The solvated PVOH resin can also be loaded with clay or clay platelets and applied as a coating onto films; the clay provides enhanced barrier characteristics to the PVOH resin with a tortuous path created to retard the permeation of gases.

Aluminum oxide and silicon oxide are clear barrier coatings that are vapor deposited in vacuum onto films in angstrom thicknesses. These coatings commonly reduce oxygen permeation rates of by two orders of magnitude. For example, aluminum oxide deposited onto a twelve micron thick PET film will reduce the oxygen transmission rate from approximately 6 cubic centimeters per 100 square inches (cc/100 in²) in 24 hours at 23° C. and 1 atmosphere of pressure to 0.09 to 0.06 cc/100 in². Other gas permeation rates and water vapor permeation rates are similarly reduced.

However, these metal oxides tend to be brittle and have historically found limited commercial use. Recently, coatings—notably acrylic based—have been applied onto the AlOx surface to mitigate the degradation of barrier by providing some measure of reduction of brittleness. For example, an AlOx coated PET film with a barrier of 0.06 cc/100 in² can be flexed ten times with a standard Gelbo flexing apparatus, and the permeation rate will increase by one order of magnitude in the range from 0.6 to 1.0 cc/100 in², and in some cases higher. With an acrylic coating applied on top of the AlOx surface, the unflexed film has a similar barrier to the uncoated film, and when this film is subjected to Gelbo flexing the barrier will again lose as much as an order of magnitude, but not more. The acrylic coating also provides a good, scratch resistant surface, again protecting the easily scratched AlOx coating. Scratched AlOx coating also gives up a significant amount of barrier, similar to what is given up with flexing. Of course, the amount of barrier forfeited by flexing or scratching is directly proportional to the amount of handling.

There is a need in the art for films with improved moisture and oxygen barrier properties, in particular for a film that maintains barrier properties after flexing, abrasion and package handling.

### SUMMARY

In some aspects, the invention concerns barrier films comprising: (i) a substrate comprising at least first and second coatings on said substrate; (ii) the first coating comprising an inorganic oxide, metal oxide or metallic coating; and (iii) the second coating capable of adhering to the substrates, wherein the second coating is polymeric; wherein the degradation of oxygen transmission rate can be reduced as a function of the coat weight of the second coating, compared to a barrier film without the second coating, when the barrier film is subjected to Gelbo-type flexing as described in ASTM F392. In some embodiments, the second coating is applied in an amount of between 0.05 and 1.0 gram per square meter.

In certain embodiments, the barrier film exhibits a change in oxygen transmission rate of less than 1 cc/100 in² after flexing according to ASTM F392 followed by measurement of oxygen permeation at 0% relative humidity. In other embodiments, the change in oxygen transmission rate is less than 0.5 cc/100 in² or less than 0.25 cc/100 in² after flexing according to ASTM F392 followed by measurement of oxygen permeation at 0% relative humidity.

In some aspects, the invention concerns barrier films comprising: (i) a substrate comprising at least first and second coatings on the substrate; (ii) the first coating comprising an inorganic oxide, metal oxide or metallic coating; and (iii) the second coating comprising a polyhydroxylic polymer or a urethane-containing polymer.

In some embodiments, the second coating is substantially free of inorganic compounds. In some embodiments, the inorganic compounds are metallic compounds and silicon containing compounds. Such metallic compounds such as metal oxides, metal hydoxides, metal alkoxides and the like. In some embodiments, metal alkoxides are of the formula M(OR)ₙ where M is Si, Ti, Al, and Zr, and R is an alkyl group such as methyl or ethyl. Some metal compounds are metal chlorides such as tin chlorides including stannous chloride, stannic chloride and mixtures thereof. Other inorganic compounds include inorganic oxides such as silicon oxides.

In some embodiments, the second coating additionally comprises (a) clay, and (b) chemical stabilizing agent, wherein the chemical stabilizing agent comprises:
materials that contain cationic functionality comprising at least one of lithium, alkyl C₂-C₆ ammonium, allyl ammonium, heterocylclic ammonium, morpholonium, ammonium and amino C₃-C₆ alkyl carboxylic acids;
lithium cations in combination with anions comprising at least one of carboxylic, phosphoric, phosphonic, sulfonic and fatty acids, lithium chelating agents, and lithium salts; and
ammonia, C₃-C₆ amine, heterocyclic amines, lithium hydroxide, morpholine, and morpholine oleate.

Preferred clays include vermiculite, montmorillonite, hectorite, sodium terasililic mica, and sodium taeniolite. In certain embodiments, the preferred clay comprises vermiculite.

In certain embodiments, the polyhydroxylic composition is polyvinyl alcohol. In another embodiment, the polyhydroxylic polymer which may be used is polyvinyl alcohol/ethylene vinyl alcohol (PVOH/EVOH) polymer.

In some preferred embodiments, the second coating comprises polyvinyl alcohol (PVOH), polyethylene imines (PEI) and urethanes and curatives for all the resin components. In certain embodiments, the preferred curatives include ethanediol (also known as glyoxal), ammonium zirconium carbonate, polyfuntional isocyanates and polyaziridine.

In some preferred embodiments, the second coating may comprise blends of polyvinyl alcohol, and polyethylene imines (PEI) and/or urethanes plus curatives for all resin components, where in certain embodiments, the preferred curative include ethanediol, ammonium zirconium carbonate, polyfuntional isocyanates and polyaziridine.

With some constructions, the first coating resides between the second coating and the substrate.

A primer coating may be optionally applied to the first coating prior to application of the second coating. The coating can be applied in any amount that provides the required structural bond strength in the targeted, end-use application. In some embodiments, the coating is applied in an amount of about 0.1 to about 0.5 g/m2. In some embodiments, the primer coating may comprise a urethane. In certain embodiments, the barrier film comprises a substrate, a first layer on the substrate comprising a metallic or metal oxide coating, a primer coating that is applied to the first coating and a second coating that is applied to primer coating, the second coating comprising a polyhydroxylic polymer (PVOH, for example, with or without a clay additive).

With some embodiments, the second coating may additionally comprise an adhesion promoter.

Additional coating may be utilized in the barrier films. For example, an additional coating may be placed on second coating to provide other barrier advantages. Such advantages include moisture barrier, abrasion resistance, and adhesion promoter. Other film candidates include the urethanes and PVOH.

Certain preferred constructions are a barrier film where the first coating is deposited onto the second coating.

While any suitable substrate may be utilized, preferred substrates comprise polyethylene terephthalate (PET), glycolised polyester (PET-G), nylon, biaxially oriented polypropylene (BOPP), oriented polypropylene, cast polypropylene, polystyrene, polyethylene (PE), polyvinyl chloride, polylactic acid (PLA), polyhydroxyalkanoate (PHA), biaxially oriented PET, biaxially oriented PETG, biaxially oriented nylon (BON), biaxially oriented polyethylene, biaxially oriented PLA, biaxially oriented PHA, polyvinylidene chloride (PVDC), ethylene vinyl acetate (EVA), PEEK, fluorinated olefins and other similar high performance and industrial films. It should be noted that, in some embodiments, PE may be low density polyethylene (LDPE), high density polyethylene (HDPE), or linear low density polyethylene (LLDEP) and blends thereof. In some preferred embodiments, the PE is oriented.

In another aspect the invention concerns methods of forming a barrier film comprising depositing a first coating and a second coating onto a substrate, wherein the first coating comprising an inorganic oxide, metal oxide or metallic coating and the second coating comprising a polyhydroxylic polymer or a urethane-containing polymer. In some embodiments, the second coating additionally comprises (a) clay, and (b) chemical stabilizing agent, wherein the chemical stabilizing agent comprises:
materials that contain cationic functionality comprising at least one of lithium, alkyl C₂-C₆ ammonium, allyl ammonium, heterocylclic ammonium, morpholonium, ammonium and amino C₃-C₆ alkyl carboxylic acids;
lithium cations in combination with anions comprising at least one of carboxylic, phosphoric, phosphonic, sulfonic and fatty acids, lithium chelating agents, and lithium salts; and
ammonia, C₃-C₆ amine, heterocyclic amines, lithium hydroxide, morpholine, and morpholine oleate.

The invention concerns laminated sheets comprising a first substrate as described above with barrier coatings and a second sheet functioning as a sealant layer facilitating the formation of bags, pouches and other container structures and an adhesive (urethane, whether water-based, solvent-based or without solvent—also referred to in the industry as “solventless”). Said sealant layers may be comprised of PE, which may be low density polyethylene (LDPE), high density polyethylene (HDPE), or linear low density polyethylene (LLDPE) and blends thereof. In some preferred embodiments, a sealable polypropylene (BOPP and CPP) may be used.

In yet another aspect, the invention concerns articles comprising one or more films described herein.

### BRIEF DESCRIPTION OF THE DRAWING

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale or proportion. In the drawings:

FIG. 1 shows a test film sample that is a 4-inch diameter circle cut to fit onto the platen of the permeation testing machine. The sample is tested without flexing (not shown), and is then flexed to simulate multiple uses of the package (film shown after flexing). The edges of the film are not flexed so that the sample will rest flat on the permeation testing machine platen, preventing leaks during testing. This flexing procedure approximates mechanical Gelbo testing.

### DETAILED DESCRIPTION OF ILLUSTRATIVE EMBODIMENTS

This invention concerns inter alia, barrier films comprising: a first substrate with at least two coatings; a first coating comprising an inorganic oxide, metal oxide or metallic coating and a second coating comprising a coating capable of adhering to said substrates. The second coating serves not only as an additional barrier layer but also serves as an abrasion resistant layer and reduces the amount of cracking in the first coating when the barrier film is flexed. During processing, various rollers and the like can cause abrasion to an uncoated film. In addition, with an uncoated film when flexed, one can see cracks in the coating when the film is held in front of a light. The instant invention serves to reduce these problems.

The invention also concerns barrier films comprising: (i) a substrate comprising at least two coatings; (ii) a first coating comprising an inorganic oxide, metal oxide or metallic coating; and (iii) a second coating comprising: (a) optionally, clay, (b) coating capable of adhering to the substrates, and (c) optionally, a chemical stabilizing agent comprising at least one of materials that contain cationic functionality comprising at least one of lithium, alkyl C₂-C₆ ammonium, allyl ammonium, heterocylclic ammonium, morpholonium, ammonium and amino C₃-C₆ alkyl carboxylic acids; lithium cations in combination with anions comprising at least one of carboxylic, phosphoric, phosphonic, sulfonic and fatty acids, lithium chelating agents, and lithium salts; and ammonia, C₃-C₆ amine, heterocyclic amines, lithium hydroxide, morpholine, and morpholine oleate.

### Unexpected Barrier Improvement

This invention demonstrates an unexpected improvement of barrier performance when, for example, an aluminum oxide (or other metal oxide, inorganic oxide or metallic) coated surface of a polyethylene terephthalate (PET) film is further coated with polyvinyl alcohol (PVOH) or a polyurethane. In some embodiments, exfoliated clays such as vermiculite are incorporated into the PVOH or polyurethane-containing polymer. Furthermore, PVOH and PVOH plus clay unexpectedly improves the barrier of this film when it is subjected to abuse such as flexing.

### Materials

Clear Oxide Coated Films:

In some embodiments, the clear oxide coatings include those based on aluminum (e.g., Al₂O₃) and silicon (e.g., SiO₂). Methods of application of the films include vapor deposition techniques (such as plasma-enhanced chemical vapor deposition) and reactive thermal evaporation. The thickness of the coating is typically 5 to 40 microns thick.

Metal Coated Films:

In some embodiments, the coating may be opaque and is based on a vapor vacuum deposition of aluminum. Metallic coatings can be added by methods known in the art, including vapor deposition techniques. Such metals can be deposited on the film by techniques well known to those skilled in the art. These techniques chemical vapor deposition (“CVD”), physical vapor deposition (“PVD”), and atomic layer deposition (“ALD”). The thickness of the metal is typically 5 to 40 microns thick.

Flexible Films:

Any suitable flexible film may be used. In some embodiments, the base film comprises one or more of polyethylene terephthalate (polyester or PET), biaxially oriented polyester (BoPET), nylon, biaxially oriented nylon (BON), polypropylene (PP), biaxially oriented polypropylene (BOPP), oriented polypropylene (OPP), cast polypropylene (CPP), polyethylene (PE) and polyvinyl chloride (PVC). The thickness of the film is typically 10 to 100 microns thick, 10-50 microns in some embodiments.

Resin Carriers for the Coating:

While any polymer capable of forming a film that has acceptable barrier properties may be used, preferred polymers capable of forming a film include one or more of a number of polymers that can be solubilized or emulsified, such as polyvinyl alcohol, co-polymers of polyvinyl alcohol (PVOH) and ethylene, polyhydroxylic polymer, polyester, EVOH, functionalized PET (sulfonated), polyurethanes, and polyvinyl acetate. The thickness of the resin coating is typically 0.05 to 1 micron thick.

PVOH is typically produced by hydrolyzing poly(vinyl acetate). In this reaction, acetate groups of poly(vinyl acetate) are replaced with alcohol groups through a hydrolysis reaction. The more acetate groups that are replaced, the greater the hydrolysis of the PVOH resin. For example, in a 95% hydrolyzed PVOH resin approximately 5% of the acetate groups remain unchanged. Similarly, in a 99% hydrolyzed PVOH resin, approximately 1% of the acetate groups remain unchanged. In the instant invention, PVOH of various degrees of hydrolysis can be used. In some cases, the degree of hydrolysis is greater than or equal to 90%, 95%, or 99%.

Urethane polymers are well known to those skilled in the art. Suitable urethane polymers include those amenable to forming aqueous dispersions.

Urethane-containing polymers include polyurethanes made by techniques known in the art. In some embodiments, a polyisocyanate compound (aromatic and aliphatic) is reacted with a compound having two or more reactive terminal hydrogen atoms. In some embodiments, the isocyanate is a diisocyanate. In some embodiments, tri-functional or higher isocyanates can be utilized alone or in mixtures with diisocyanates. In some embodiments, aliphatic isocyanates are preferred.

Suitable compounds with reactive terminal hydrogens include polyols such as poly(ethylene glycol), poly(propylene glycol), or polyester polyol. These compounds can be reacted with the isocyanate compound either in the presence or absence of catalysts.

In some embodiments, the urethanes can have polar sites attached thereto to promote water compatibility. Such sites include, carboxylic acid, ether, sulfonic, sulfonium, sulfhydryl, and ammonium groups. See, for example, PCT Patent Application No. WO98/03860.

### Cross Linking Agents for Resin Carriers Used for the Coating:

In certain embodiments, the cross-linking agent comprises ethanedial, cyclic urea glyoxal condensate, or blends thereof. In some embodiments, the cross-linking agent comprises ammonium zirconium carbonate. Other cross-linking agents used for polyurethanes may include polyfunctional isocyanates and polyaziridines. In some embodiments, the amount of cross-linker is 0.1 to 50 percent based on weight of the polymer capable of forming a film.

Inorganic Clays and Impermeable Media:

It is preferred that the vermiculite have an aspect ratio of at least 5,000, or in some embodiments, at least 10,000. As is known in the art, “aspect ratio” is length or width (e.g. breadth) divided by thickness. Other embodiment include such clays as montmorillonite, hectorite, sodium terasililic mica and sodium taeniolite. Still other impermeable media include colloidal silica. Clays are normally applied as an aqueous dispersion. In some embodiments, the weight percent of solids is 0.5-10%. In other embodiments, the weight percent of solids is 3-8% or 4-6%.

Chemical Stabilizing Agents:

Chemical stabilizing agents are used for maintaining the singularity of the vermiculite clay platelets. These chemical stabilizing agents can be selected from materials that contain cationic functionality selected from lithium, alkyl C2-C6 ammonium, allyl ammonium, heterocylclic ammonium, morpholonium, ammonium and amino C3-C6 alkyl carboxylic acids; lithium cations in combination with anions selected from carboxylic, phosphoric, phosphonic, sulfonic and fatty acids, lithium chelating agents, and lithium salts; lithium salts of carboxylic acids, ammonia, C₃-C₆ amine, heterocyclic amines, lithium hydroxide, morpholine, and morpholine oleate. In one embodiment, these dispersion agents are used at a weight ratio of dispersion agent to vermiculite ranges from about 0.02 to about 1.0, preferably about 0.04 to about 0.5.

Adhesive:

In some embodiments, the invention uses an adhesive mixture layer deposed between first and second substrates. While any suitable adhesive can be used, in some embodiments, one or more of polyurethanes, polyethylene vinyl acetates, epoxies, cyanoacrylates, starches and dextrins are used. Certain adhesives are an aqueous solution or emulsion. The adhesive mixture may optionally contain a cross-linking agent. In some embodiments, the adhesive mixture layer has a dry coat weight of between 0.5 and 7 gm/m².

The present invention is exemplified by the following examples which are not intended to be limiting.

### Articles

A barrier film of the invention may also be used in the production of articles which are used for packaging of products benefiting from a protective barrier. Such products include bags, bottles, cups, jars and trays.

Often two or more polymer materials are joined in a coextrusion process to produce tailored film or sheet products adapted to a particular end use. One or more polymer types in two or more layers of melt are melted in separate extruders and joined together in a single coextrusion die layering single extrudates together in a single film to have a finished film with versatile properties derived from the individual layers. Layers of the different polymers or resins can be combined by parallel extrusion of the different polymers. The film can be processed conventionally and may be oriented after cooling. Films can contain a variety of additives such as antioxidants, heat stabilizers, UV stabilizers, slip agents, fillers, and anti-block agents.

### Definitions

The use of “a” or “an” are employed to describe elements and components of the invention. This is done merely for convenience and to give a general sense of the invention. This description should be read to include one or at least one and the singular also includes the plural unless it is obvious that it is meant otherwise.

As used herein, the terms “about” and “at or about” mean that the amount or value in question can be the value designated some other value approximately or about the same. It is generally understood, as used herein, that it is the nominal value indicated ±5% variation unless otherwise indicated or inferred. It is understood that where “about” is used before a quantitative value, the parameter also includes the specific quantitative value itself, unless specifically stated otherwise.

The term “comprising” can include the embodiments “consisting of” and “consisting essentially of.”

Unless defined otherwise, all technical and scientific terms used herein have the same meaning as commonly understood by one of ordinary skill in the art to which this disclosure belongs.

Unless stated otherwise, any test methods cited herein are to the most recent version available at the time of filing.

### Aspects

Aspect 1. A barrier film comprising: (i) a substrate comprising at least first and second coatings on the substrate; (ii) the first coating comprising an inorganic oxide, metal oxide or metallic coating; and (iii) the second coating capable of adhering to the substrates, wherein the second coating is polymeric and is between 0.05 and 1.0 gram per square meter; wherein the degradation of oxygen transmission rate is reduced when compared to a barrier film without the second coating when the barrier film is subjected to Gelbo-type flexing as described in ASTM F392.

Aspect 2. The barrier film of Aspect 1, wherein the second coating comprising a polyhydroxylic polymer or a urethane-containing polymer and, optionally, a cross-linking agent.

Aspect 3. The barrier film of Aspect 1 or Aspect 2, wherein the second coating is substantially free of inorganic compounds.

Aspect 4. The barrier film of any one of Aspects 1-3, wherein the second coating additionally comprises: (a) clay; (b) chemical stabilizing agent, wherein the chemical stabilizing agent comprises:
materials that contain cationic functionality comprising at least one of lithium, alkyl C₂-C₆ ammonium, allyl ammonium, heterocylclic ammonium, morpholonium, ammonium and amino C₃-C₆ alkyl carboxylic acids;
lithium cations in combination with anions comprising at least one of carboxylic, phosphoric, phosphonic, sulfonic and fatty acids, lithium chelating agents, and lithium salts; and
ammonia, C₃-C₆ amine, heterocyclic amines, lithium hydroxide, morpholine, and morpholine oleate; and
(c) cross-linking agent.

Aspect 5. The barrier film of Aspect 4, wherein the clay is one or more of vermiculite, montmorillonite, hectorite, sodium terasililic mica, and sodium taeniolite.

Aspect 6. The barrier film of Aspect 4, wherein the clay comprises vermiculite,

Aspect 7. The barrier film any one of Aspects 1-6, wherein the first coating resides between the second coating and the substrate.

Aspect 8. The barrier film of Aspect 7, wherein a primer coating is between the first coating and the second coating. In some embodiments, the primer coating is derived from a water-based polyurethane emulsion.

Aspect 9. The barrier film of any one of Aspects 1-8, wherein the second coating comprises an adhesion promoter.

Aspect 10. The barrier film of any one of Aspects 1-9, comprising an additional coating onto the second coating to provide other barrier properties such as moisture resistance, abrasion resistance, or adhesion promoter.

Aspect 11. The barrier film of any one of Aspects 1-10, wherein the second coating is deposited onto the first coating.

Aspect 12. The barrier film of any one of Aspects 1-11, wherein the polyhydroxylic polymer comprises polyvinyl alcohol.

Aspect 13. The barrier film of any one of Aspects 1-12, wherein the substrate comprises polyethylene terephthalate (PET), glycolised polyester (PET-G), nylon, biaxially oriented polypropylene (BOPP), oriented polypropylene, cast polypropylene, polystyrene, polyethylene (PE), polyvinyl chloride, polylactic acid (PLA), polyhydroxyalkanoate (PHA), biaxially oriented PET, biaxially oriented PETG, biaxially oriented nylon (BON), biaxially oriented polyethylene, biaxially oriented PLA, biaxially oriented PHA, polyvinylidene chloride (PVDC), ethylene vinyl acetate (EVA), PEEK and fluorinated olefins.

Aspect 14. The barrier film of any one of Aspects 1-13, wherein the barrier film exhibits a change in oxygen transmission rate of less than 1 cc/100 in² after flexing according to ASTM F392 followed by measurement of oxygen permeation at 0% relative humidity.

Aspect 15. The barrier film of any one of Aspects 1-14, wherein the barrier film exhibits a change in oxygen transmission rate of less than 0.5 cc/100 in² after flexing according to ASTM F392 followed by measurement of oxygen permeation at 0% relative humidity.

Aspect 16. The barrier film of any one of Aspects 1-15, wherein the substrate comprises polyester.

Aspect 17. The barrier film of any one of Aspects 1-16, wherein the metal oxide comprises an aluminum oxide.

Aspect 18. The barrier film of any one of Aspects 1-16, wherein the metallic coating comprises aluminum.

Aspect 19. The barrier film of any one of Aspects 1-16, wherein the inorganic oxide comprises an oxide of silicon.

Aspect 20. A method of forming a barrier film comprising depositing a first coating and a second coating onto a substrate, wherein the first coating comprising an inorganic oxide, metal oxide or metallic coating; and the second coating comprising a polyhydroxylic polymer or a urethane-containing polymer.

Aspect 21. The method of Aspect 20, wherein the second coating additionally comprising
(a) clay, and
(b) chemical stabilizing agent, wherein the chemical stabilizing agent comprises:
   materials that contain cationic functionality comprising at least one of lithium, alkyl C₂-C₆ ammonium, allyl ammonium, heterocylclic ammonium, morpholonium, ammonium and amino C₃-C₆ alkyl carboxylic acids;
   lithium cations in combination with anions comprising at least one of carboxylic, phosphoric, phosphonic, sulfonic and fatty acids, lithium chelating agents, and lithium salts; and
   ammonia, C₃-C₆ amine, heterocyclic amines, lithium hydroxide, morpholine, and morpholine oleate.

Aspect 22. The method of Aspect 20 or Aspect 21, wherein the clay comprises vermiculite,

Aspect 23. The method of any one of Aspects 20-22, wherein the first coating resides between the second coating and the substrate.

Aspect 24. The method of any one of Aspects 20-23, wherein a primer coating is applied to the first coating prior to application of the second coating.

Aspect 25. The method of any one of Aspects 20-24, wherein the substrate comprises polyester.

Aspect 26. The method of Aspects 20-25, wherein the metal oxide comprises an aluminum oxide.

Aspect 27. The method of one of Aspects 20-25, wherein the metallic coating comprises aluminum.

Aspect 28. An article comprising a barrier film of any one of Aspects 1-19.

Aspect 29. A barrier film comprising: (i) a substrate comprising at least first and second coatings on the substrate; (ii) the first coating comprising an inorganic oxide, metal oxide or metallic coating; and (iii) the second coating capable of adhering to at least one of the first coating and the substrate, the second coating comprising: (a) a polymer capable of forming film; and (b) clay; wherein the degradation of oxygen transmission rate is reduced when compared to a barrier film without the second coating when the barrier film is subjected to Gelbo-type flexing as described in ASTM F392.

Aspect 30. The barrier film of Aspect 29, wherein the clay is one or more of vermiculite, montmorillonite, hectorite, sodium terasililic mica, and sodium taeniolite.

Aspect 31. The barrier film of Aspect 29, wherein the second coating comprises vermiculite; and the second coating additionally comprises (c) chemical stabilizing agent, wherein the chemical stabilizing agent comprises one or more of: (i) materials that contain cationic functionality comprising at least one of lithium, alkyl C2-C6 ammonium, allyl ammonium, heterocylclic ammonium, morpholonium, ammonium and amino C3-C6 alkyl carboxylic acids; (ii) lithium cations in combination with anions comprising at least one of carboxylic, phosphoric, phosphonic, sulfonic and fatty acids, lithium chelating agents, and lithium salts; and (iii) ammonia, C3-C6 amine, heterocyclic amines, lithium hydroxide, morpholine, and morpholine oleate; and (d) optionally, a cross-linking agent.

Aspect 32. The barrier film of any one of Aspects 29-31, wherein the polymer capable of forming a film comprises a polyhydroxylic polymer or a urethane-containing polymer and the second coating comprises a cross-linking agent.

Aspect 33. The barrier film of any one of Aspects 29-32, wherein the first coating resides between the second coating and the substrate.

Aspect 34. The barrier film of any one of Aspects 29-33, comprising an additional coating onto the second coating to provide an improvement of one or more of moisture resistance, abrasion resistance, and adhesion promotion.

Aspect 35. The barrier film of Aspect 32, wherein the polyhydroxylic polymer comprises polyvinyl alcohol.

Aspect 36. The barrier film of any one of Aspects 29-35, wherein the substrate comprises polyethylene terephthalate (PET), glycolised polyester (PET-G), nylon, biaxially oriented polypropylene (BOPP), oriented polypropylene, cast polypropylene, polystyrene, polyethylene (PE), polyvinyl chloride, polylactic acid (PLA), polyhydroxyalkanoate (PHA), biaxially oriented PET, biaxially oriented PETG, biaxially oriented nylon (BON), biaxially oriented polyethylene, biaxially oriented PLA, biaxially oriented PHA, polyvinylidene chloride (PVDC), ethylene vinyl acetate (EVA), PEEK and fluorinated olefins.

Aspect 37. The barrier film of any one of Aspects 29-36, wherein the barrier film exhibits a change in oxygen transmission rate of less than 1.0 cc/100 in2 after flexing according to ASTM F392 followed by measurement of oxygen permeation at 0% relative humidity.

Aspect 38. The barrier film of any one of Aspects 29-37, wherein the substrate comprises polyester.

Aspect 39. The barrier film of any one of Aspects 29-38, wherein the metal oxide comprises an aluminum oxide.

Aspect 40. The barrier film of any one of Aspect 29-38, wherein the metallic coating comprises aluminum.

Aspect 41. The barrier film of any one of Aspects 29-38, wherein the inorganic oxide comprises an oxide of silicon.

Aspect 42. A method of forming a barrier film comprising depositing a first coating and a second coating onto a substrate, wherein the first coating comprising an inorganic oxide, metal oxide or metallic coating; and the second coating comprising: (a) polymer capable of forming a film; and (b) clay.

Aspect 43. The method of Aspect 42, wherein the clay is one or more of vermiculite, montmorillonite, hectorite, sodium terasililic mica, and sodium taeniolite.

Aspect 44. The method of Aspect 42 or Aspect 43, wherein the second coating comprises vermiculite; and the second coating additionally comprises (c) chemical stabilizing agent, wherein the chemical stabilizing agent comprises one or more of (i) materials that contain cationic functionality comprising at least one of lithium, alkyl C2-C6 ammonium, allyl ammonium, heterocylclic ammonium, morpholonium, ammonium and amino C3-C6 alkyl carboxylic acids; (ii) lithium cations in combination with anions comprising at least one of carboxylic, phosphoric, phosphonic, sulfonic and fatty acids, lithium chelating agents, and lithium salts; and (iii) ammonia, C3-C6 amine, heterocyclic amines, lithium hydroxide, morpholine, and morpholine oleate; and (d) optionally, cross-linking agent.

Aspect 45. The method of any one of Aspects 42-44, wherein the polymer capable of forming a film is a polyhydroxylic polymer or a urethane-containing polymer.

Aspect 46. The method of any one of Aspects 42-45, wherein the first coating resides between the second coating and the substrate.

Aspect 47. The method of any one of Aspects 42-46, wherein the metal oxide comprises an aluminum oxide.

Aspect 48. The method of any one of Aspects 42-46, wherein the metal coating comprises aluminum.

Aspect 49. An article comprising a barrier film of any one of Aspects 29-41.

### EXAMPLES

The invention is illustrated by the following examples that are intended to illustrative but non-limiting in nature.

### Example 1

A batch of 17.5 percent concentration of polyvinyl alcohol (PVOH) was prepared by dissolving 90 grams of Exceval AQ-4104 (Exceval is a trademark of Kuraray America, Inc.) in 425 grams of de-ionized water. The PVOH was added to de-ionized water with the water at room temperature, with intensive mixing during the addition, and the temperature of the mixture was slowly increased to 90° C. The solution was stabilized against microbes by adding 1.03 grams, or 0.2 percent by weight of PVOH plus water of liquid 1,2-benzisothiazolin-3-one, or Proxel GXL (Proxel is a trademark of Arch Chemicals). The solution was stirred for 40 minutes under heated conditions, until all the PVOH was completely dissolved. The solution was subsequently cooled and filtered through a 50 mesh stainless steel screen to remove solid impurities. The concentration was checked using a hand-held refractometer and adjusted to account for the water evaporated during the solubilizing step. The evaporated water was replaced with de-ionized water so that the refractometer reading was 19.6 BRIX. Based on a known relationship of BRIX to concentration, a reading of 19.6 BRIX corresponds to 17.5 percent solids concentration of PVOH in water.

A masterbatch solution using the solvated PVOH batch from above was prepared as follows. Into a stainless steel pot was placed 157.5 grams of de-ionized water. To this water was added 3.4 grams of lithium hydroxide monohydrate and the mixture was stirred at room temperature until the lithium compound was completely dissolved. (Lithium hydroxide monohydrate is supplied by Lithium Corporation of America, as well as various distributors worldwide.) Following this solubilizing step, 38.5 grams of isopropyl alcohol was added to the batch and mixed.

Next 500 grams of the solvated PVOH described above was added to the pot. Glyoxal, a cross-linking agent for the PVOH was added at 44.1 grams to the masterbatch. (Glyoxal 40L is the product designation used by Clariant for a 40% concentration of ethanedial in water. Similarly Glyoxal 40% is a product designation used by BASF for a 40% solution of ethanedial in water).

Forty (40) grams of the masterbatch prepared above was placed into a plastic cup, and 7 grams of a proprietary adhesion promoter, AP-100 was added to the contents using high shear mixing. (AP-100 is a product designation for a proprietary adhesion promoter from NanoPack Inc.) The resulting mixture's solids content was calculated to be 13 percent. This mixture was subsequently diluted with various amounts of de-ionized water and coated with a #3 Meyer Bar on top of the aluminum oxide coated side of AX425 to provide three different dry coat weights. (AX425 is JBF-RAK's (UAE) 48 gauge (12 micron) polyester terephthalate (PET) flexible film coated on one side with a plasma deposition of aluminum oxide.) The dried solid coat weights of the PVOH-based coatings were measured at 0.05, 0.09 and 0.21 gram per square meter.

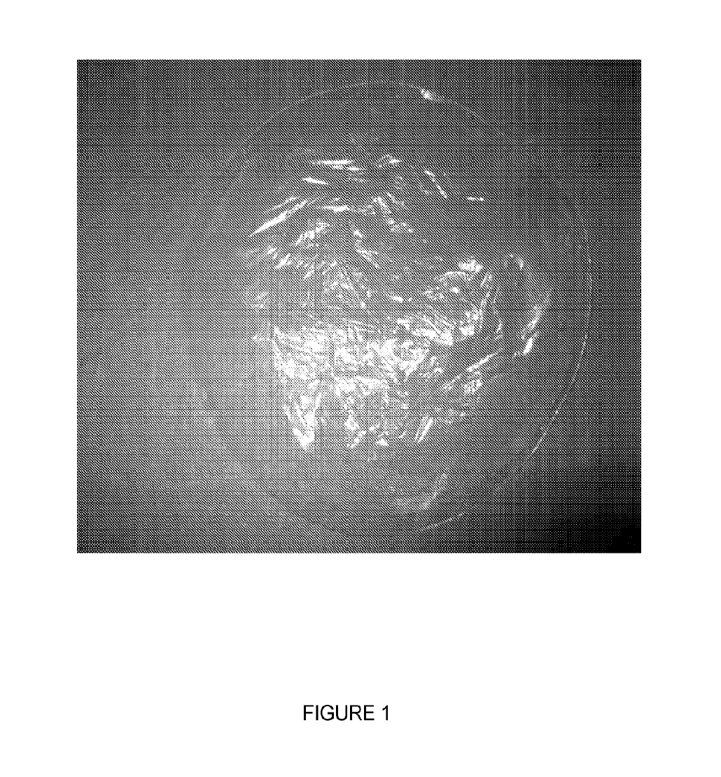

The coated films were then tested for permeability using an Illinois Instruments Model 8001 permeation testing machine at 0% relative humidity. After testing these films in this fashion, the films were removed and were also tested after flexing. The flexing preparation consisted of twisting and crunching the film between the thumbs and forefingers of both hands, such that the films appeared as shown in FIG. 1. This flexing approximates Gelbo testing, without destroying the edges of the film, so that a smooth surface is maintained for excellent adhesion and sealing to the platens of the permeation testing apparatus.

The permeation testing results of uncoated AX425, PVOH-based coated (no platelets) AX425 and AC425 (JBF-RAK's AX425 coated with acrylic at 0.05 gram per square meter) are listed in Table 1.

AX425 is not supplied to the market in an uncoated format, because the AlOx is prone to being easily scratched and cracked. AX425 is coated with an acrylic, to provide physical protection, in order to maintain the integrity of the film's barrier properties, notably oxygen barrier. JBF-RAK's acrylic coated version of AX425 is designated AC425.

TABLE 1
PVOH coating without clay additive

| | | Smooth Film | Flexed Film^{see FIG. 1} |
|---|---|---|---|
| | Coat Weight, | Barrier, cc/100 in² | Barrier, cc/100 in² at |
| Film | gsm | at 0% RH | 0% RH^{Note 2} |
| AX425 | No coating | 0.0456 | 0.699 |
| | 0.09 | 0.036 | — |
| | 0.21 | 0.030 | 0.360 |
| AC425^{Note 1} | 0.05 acrylic | 0.0305 | 0.613 |

^{Note 1}AC425 is acrylic coated AX425, with an acrylic coat weight of 0.05 gsm.
^{Note 2}The complete destruction of the barrier coating with flexing would expose the bare 48 gauge PET film, which has a barrier of ~6 cc/100 in² at 0% RH.

### Example 2

A batch of 10.5 percent concentration of polyvinyl alcohol (PVOH) was prepared by dissolving 8.1 kilograms of Elvanol 90-50 (Elvanol is a trademark of DuPont) in 70.5 kilograms of de-ionized water at 80° C. PVOH was added to pre-heated water with intensive mixing during the addition. The solution was stabilized against microbes by dissolving 0.16 kilograms, or 0.2 percent by weight of the PVOH plus water of 1,2-benzisothiazolin-3-one, or Proxel GXL. The solution was stirred and heated for four hours to dissolve all the PVOH and microbiostat. The solution was subsequently cooled and filtered through cheesecloth supported on a stainless steel screen to remove solid impurities. The concentration was checked using a hand-held refractometer and adjusted to account for the water evaporated during the solubilizing step. The evaporated water was replaced with de-ionized water so that the refractometer reading was 11.8 BRIX. Based on a known relationship of BRIX to concentration, a reading of 11.8 BRIX corresponds to approximately 10.5 percent solids concentration of PVOH in water.

A masterbatch solution using the solvated PVOH batch from above was prepared as follows. Into a stainless steel vessel was placed 32.8 kilograms of de-ionized water. To this water was added 300 grams of lithium hydroxide monohydrate and the mixture was stirred at room temperature until the lithium compound was dissolved. Following this solubilizing step, 5.7 kilograms of isopropyl alcohol was added to the batch and mixed. Next 77.3 kilograms of the solvated PVOH described above was added to the vessel. And finally, the masterbatch was completed with an addition of 3.85 kilograms of Glyoxal 40L.

To 100 kilograms of the masterbatch prepared above, 6.3 kilograms of Microlite 963 vermiculite/water slurry was added, and the mixture was gently stirred. (Microlite 963 manufactured by Specialty Vermiculite Corporation.) Finally, 10.0 kilograms of AP-100, a proprietary adhesion promoter was added to the masterbatch/Microlite mixture. The adhesion promoter was added into a votex in the mixture, which was created with a propeller type mixing head driven at high speed. The mixture was mixed for an additional 5 minutes following the completion of the adhesion promoter addition.

AX425, a 48 gauge (12 micron) biaxially oriented polyester terephthalate (PET) coated on one side with a plasma deposition of aluminum oxide (AlOx) at several nanometers thickness was coated on top of the AlOx directly with the coating mixture described above. (AX425 is manufactured by JBF-RAK, located in the United Arab Emirates.) The coating was applied on a PSi SC1000, 64-inch wide direct gravure press, using several different cylinders to achieve several different coat weights of dried barrier coating. The description of the cylinders and resulting coat weights are listed in Table 2.

TABLE 2

| Cylinder | | Cell volume, | Dry coat weight, |
|---|---|---|---|
| designation | Lines per inch | bcm^{Note 3} | gram/m² |
| CL20 | 300 | 2.0 | 0.12 |
| CL33 | 250 | 3.3 | 0.35 |
| CL69 | 170 | 6.9 | 0.38 |
| CL100 | 150 | 10.0 | 0.68 |

^{Note 3}bcm is billion cubic microns per square inch. This number can be converted to cubic centimeters per square meter by multiplying bcm by 1.5500031.

A comparison of oxygen barrier properties for JBF-RAK's uncoated film, acrylic coated film and the four variations of AX425 coated with the barrier composition described above using the four coat weights shown above are presented in Table 3. The films tested were placed into the testing machine in their smooth, unflexed format. And, they were also tested after flexing.

TABLE 3
PVOH coating with clay additive

| | Coat | Smooth Film | Flexed Film |
|---|---|---|---|
| | Weight, | Barrier, cc/100 in² | Barrier, cc/100 in² |
| Film | gsm | at 0% RH^{note2} O₂ | at 0% RH O₂^{Note 2} |
| AC425 | 0.05 acrylic | 0.0305 | 0.613 |
| AX425 | 0.00 | 0.0456 | 0.699 |
| | 0.12 | 0.0028 | 0.0500 |
| | 0.35 | 0.00038 | 0.0229 |
| | 0.38 | 0.00037 | 0.0217 |
| | 0.68 | <0.00005 | 0.0131 |

^{Note 2}The complete destruction of the barrier coating with flexing would expose the bare 48 gauge PET film, which has a barrier of ~6 cc/100 in² at 0% RH.

### Example 3

A batch of 10.5 percent concentration of polyvinyl alcohol (PVOH) was prepared by dissolving 8.1 kilograms of Elvanol® 90-50 (Elvanol is a trademark for a polyvinyl alcohol product marketed by DuPont) in 70.5 kilograms of de-ionized water at 80° C. PVOH was added to pre-heated water with intensive mixing during the addition. The solution was stabilized against microbes by dissolving 0.16 kilograms, or 0.2 percent by weight of the PVOH plus water of 1,2-benzisothiazolin-3-one, or Proxel GXL. The solution was stirred and heated for four hours to dissolve all the PVOH and microbiostat. The solution was subsequently cooled and filtered through cheesecloth supported on a stainless steel drum to remove solid impurities. The concentration was checked using a hand-held refractometer and adjusted to account for the water evaporated during the solubilizing step. The evaporated water was replaced with de-ionized water so that the refractometer reading was 11.8 BRIX. Based on a known relationship of BRIX to concentration, a reading of 11.8 BRIX corresponds to approximately 10.5 percent solids concentration of PVOH in water.

A masterbatch solution using the solvated PVOH batch from above was prepared as follows. Into a stainless steel vessel was placed 32.8 kilograms of de-ionized water. To this water was added 5.7 kilograms of isopropyl alcohol and the batch was mixed. Next 77.3 kilograms of the solvated PVOH described above was added to the vessel. And finally, the masterbatch was completed with an addition of 3.85 kilograms of Glyoxal 40L.

To 100 kilograms of the masterbatch prepared above, 10.0 kilograms of AP-100, a proprietary adhesion promoter was added to the masterbatch and was mixed for 5 minutes with a propeller type mixer driven at high speed. The calculated solids concentration of this mixture was 7.9%. To 200 grams of this mixture, and additional 139 grams of distilled water was mixed, and the resulting concentration of the mixture was calculated at 2.2%.

AX410, a 48 gauge (12 micron) biaxially oriented polyester terephthalate (PET) coated on one side with a plasma deposition of aluminum oxide (AlOx) was coated on top of the AlOx directly with the PVOH-based, diluted coating described above. (AX410 is manufactured by JBF-RAK, located in the United Arab Emirates.) The coating was applied using a #3 Meyer Bar. The resulting dry coat weight of the PVOH-based coating was 0.12 gram per square meter.

A comparison of oxygen barrier properties for JBF-RAK's AX410 film without the PVOH-based coating, with the diluted PVOH-based coating as described above and JBF-RAK's standard acrylic coated AC410 film are presented in Table 4. (AC410 is JBF-RAK's AX410 coated with 0.25 gram per square meter of acrylic for some retention of barrier properties with flexing and for ink receptivity.) The films tested were placed into the testing machine in their smooth, unflexed format. And, they were also tested after flexing, as described above in Example 1.

TABLE 4

| | | Smooth Film | Flexed Film^{see FIG. 1} |
|---|---|---|---|
| | Coat Weight, | Barrier, cc/100 in² | Barrier, cc/100 in² at |
| Film | gsm | at 0% RH | 0% RH^{Note 2} |
| AX410 | No coating | 0.214 | 6.60 |
| | 0.12 (PVOH) | 0.031 | 0.38 |
| AC410 | 0.25 (acrylic) | 0.097 | 6.54 |

^{Note 2}The complete destruction of the barrier coating with flexing would expose the bare 48 gauge PET film, which has a barrier of ~6 cc/100 in² at 0% RH.

### Example 4

The undiluted PVOH-based coating prepared in Example 3 above was applied to the aluminum oxide coated side of AX410 on a UTECO flexographic press using a coating cylinder engraved at 105 lines per centimeter and a cell volume of 8.1 cubic centimeters per square meter. The resulting dry coat weight of the PVOH-based coating was 0.16 gram per square meter.

A comparison of oxygen barrier properties for JBF-RAK's uncoated film (AX410) and the coated film described above are presented in Table 5. The films tested were placed into the testing machine in their smooth, unflexed format. And, they were also tested after flexing, as described above in Example 1.

TABLE 5

| | | Smooth Film | Flexed Film^{see FIG. 1} |
|---|---|---|---|
| | Coat Weight, | Barrier, cc/100 in² | Barrier, cc/100 in² at |
| Film | gsm | at 0% RH | 0% RH^{Note 2} |
| AX410 | No coating | 0.180 | 6.65 |
| | 0.12 (PVOH) | 0.025 | 0.68 |

^{Note 2}The complete destruction of the barrier coating with flexing would expose the bare 48 gauge PET film, which has a barrier of ~6 cc/100 in² at 0% RH.

### Example 5

A batch of 9.3 percent concentration of polyvinyl alcohol (PVOH) was prepared by dissolving 1.09 kilograms pounds of Soarnol OKS-8049 (Soarnol is a trademark of Soarus, LLC, a subsidiary of Nippon Gohsei of Japan) in 10.62 kilograms of de-ionized water. The PVOH was added to the water at 24° C. with intensive mixing during the addition, and the temperature of the mixture was slowly raised to 85° C. while the solution was continually stirred, until the PVOH was dissolved. The solution was subsequently cooled and filtered through cheesecloth to remove solid impurities. The concentration was checked using a hand-held refractometer and adjusted to account for the water evaporated during the solubilizing step. The evaporated water was replaced with de-ionized water so that the refractometer reading was 10.4 BRIX. Based on a known relationship of BRIX to concentration, a reading of 10.4 BRIX corresponds to approximately 9.3 percent solids concentration of PVOH in water.

A masterbatch solution using the solvated PVOH batch from above was prepared as follows. Into a plastic pail 5.63 kilograms of de-ionized water. To this water was added 0.82 kilograms of isopropyl alcohol and the batch was mixed. Next 11.72 kilograms of the solvated PVOH described above was added to the pail while stirring continuously. The pH of the mixture was adjusted to 8.65 with a technical grade of NaOH.

To the pH adjusted masterbatch prepared above, 41.5 grams of NeoRez R-9330, a urethane dispersion designed to provide adhesion was added and mixed for 1 minute. (NeoRez is a trademark of DSM.) Next, 103.8 grams of MICA A131X polyethylene imine, another adhesion promoter was added to the masterbatch and mixed for 1 minute. (MICA A131X is a trademark of MICA Corporation, Shelton, Conn., USA.)

Finally, 30 grams of polyaziridine were added to the masterbatch described above and mixed at high speed. The mixture was stirred for an additional 5 minutes after the polyaziridine addition.

AX410 described above was coated on top of the aluminum oxide coating with the coating mixture described above on a UTECO flexographic press using a coating cylinder engraved at 350 lines per centimeter and a cell volume of 3.8 cubic centimeters per square meter. The resulting dry coat weight of the PVOH-based coating was 0.05 gram per square meter.

A comparison of oxygen barrier properties for the uncoated film, and the coated film described above are presented in Table 6. The films tested were placed into the testing machine in their smooth, unflexed format. And, they were also tested after flexing, as described above in Example 1.

TABLE 6

| | | Smooth Film | Flexed Film^{see FIG. 1} |
|---|---|---|---|
| | Coat Weight, | Barrier, cc/100 in² | Barrier, cc/100 in² at |
| Film | gsm | at 0% RH | 0% RH^{Note 2} |
| AX410 | No coating | 0.180 | 6.65 |
| | 0.05 (PVOH) | 0.202 | 4.10 |

^{Note 2}The complete destruction of the barrier coating with flexing would expose the bare 48 gauge PET film, which has a barrier of ~6 cc/100 in² at 0% RH.

### Example 6

A 36 gauge (9 micron) polyester film metallized with aluminum to an optical density of 2.4 was coated with Michem 1852 urethane (PUD) primer on a UTECO flexographic press, using a coating cylinder engraved at 350 lines per centimeter and a cell volume of 3.8 cubic centimeters per square meter. The resulting dry coat weight of the urethane coating was 0.10 gram per square meter. (Michem is a trademark of Michelman, Inc., Cincinnati, Ohio, USA.)

A comparison of oxygen barrier properties for the uncoated film, and the coated film described above are presented in Table 7. The films tested were placed into the testing machine in their smooth, unflexed format. And, they were also tested after flexing, as described above in Example 1.

TABLE 7

| | | Smooth Film | Flexed Film^{see FIG. 1} |
|---|---|---|---|
| | Coat Weight, | Barrier, cc/100 in² | Barrier, cc/100 in² at |
| Film | gsm | at 0% RH | 0% RH^{Note 4} |
| 36 ga. | No coating | 0.04 | 8.1^{note 1} |
| Metallized | 0.10 (PUD) | 0.06 | 7.3^{note 1} |
| PET film | | | |

^{Note 4}The complete destruction of the barrier coating with flexing would expose the bare 36 gauge PET film, which has a barrier of ~8 cc/100 in² at 0% RH.

### Example 7

The primed metallized film from Example 6 was further coated on a UTECO flexographic press coated with the barrier coating described in Example 2, using a coating cylinder engraved at 105 lines per centimeter and a cell volume of 11.6 cubic centimeters per square meter. The resulting dry coat weight of the barrier coating was 0.25 gram per square meter.

A comparison of oxygen barrier properties for the uncoated, metallized film, and the coated film described above are presented in Table 8. The films tested were placed into the testing machine in their smooth, unflexed format. And, they were also tested after flexing, as described above in Example 1.

TABLE 8

| | | Smooth Film | Flexed Film^{see FIG. 1} |
|---|---|---|---|
| | Coat Weight, | Barrier, cc/100 in² | Barrier, cc/100 in² at |
| Film | gsm | at 0% RH | 0% RH^{Note 4} |
| 36 ga. | No coating | 0.04 | 8.1 |
| Metallized | 0.10 (PUD) | 0.01 | 1.1 |
| PET film | Plus | | |
| | 0.25 (barrier | | |
| | coating) | | |

^{Note 4}The complete destruction of the barrier coating with flexing would expose the bare 36 gauge PET film, which has a barrier of ~8 cc/100 in² at 0% RH.

### Example 8

A 70 gauge (180 BOPP film metallized with aluminum to an optical density of 1.7 was coated with a Fuller urethane primer system consisting of 14.5 kilograms of WD4047 urethane emulsion polymer, 25 kilograms of water, 290 grams of polyaziridine XR2990, and 8 grams of anti-foam WD6300. The primer system was applied using a PSi SC1000, 64-inch wide single station, direct gravure press using a coating cylinder engraved at 100 lines per centimeter and a cell volume of 5.1 cubic centimeters per square meter. The resulting dry coat weight of the urethane coating was 0.35 gram per square meter. (WD4047, XR2990 and WD6300 are products of H.B. Fuller Company, St. Paul, Minn., USA.)

The urethane primed film was subsequently coated on the same direct gravure press with the same cylinder using the coating described in Example 2, resulting in a dry coat weight of 0.28 gram per square meter.

A comparison of oxygen barrier properties for the urethane primed film and the urethane primed and barrier coated film are presented in Table 9. The films tested were placed into the testing machine in their smooth, unflexed format. And, the urethane primed, barrier coated film was also tested after flexing, as described above in Example 1.

TABLE 9

| | | Smooth Film | Flexed Film^{see FIG. 1} |
|---|---|---|---|
| | Coat Weight, | Barrier, cc/100 in² | Barrier, cc/100 in² at |
| Film | gsm | at 0% RH | 0% RH^{Note 5} |
| 70 ga. | 0.35 (PUD) | 0.50 | — |
| Metallized | 0.35 (PUD) | 0.17 | 15.5 |
| BOPP film | plus | | |
| | 0.25 (barrier | | |
| | coating) | | |

^{Note 5}The complete destruction of the barrier coating with flexing would expose the bare 70 gauge BOPP film, which has a barrier of ~100 cc/100 in² at 0% RH.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A barrier film comprising:
(i) a substrate comprising at least first and second coatings on the substrate;
(ii) the first coating comprising an inorganic oxide, metal oxide or metallic coating; and
(iii) the second coating capable of adhering to the substrates, wherein the second coating is polymeric;
wherein the degradation of oxygen transmission rate is reduced when compared to a barrier film without the second coating when the barrier film is subjected to Gelbo-type flexing as described in ASTM F392.

2. The barrier film of claim 1, wherein the second coating comprising a polyhydroxylic polymer or a urethane-containing polymer and, optionally, a cross-linking agent.

3. The barrier film of claim 1, wherein the second coating is substantially free of inorganic compounds.

4. The barrier film of claim 1, wherein the second coating additionally comprises:
(a) clay;
(b) chemical stabilizing agent, wherein the chemical stabilizing agent comprises one or more of:
materials that contain cationic functionality comprising at least one of lithium, alkyl C₂-C₆ ammonium, allyl ammonium, heterocylclic ammonium, morpholonium, ammonium and amino C₃-C₆ alkyl carboxylic acids;
lithium cations in combination with anions comprising at least one of carboxylic, phosphoric, phosphonic, sulfonic and fatty acids, lithium chelating agents, and lithium salts; and
ammonia, C₃-C₆ amine, heterocyclic amines, lithium hydroxide, morpholine, and morpholine oleate; and
(c) cross-linking agent.

5. The barrier film of claim 4, wherein the clay is one or more of vermiculite, montmorillonite, hectorite, sodium terasililic mica, and sodium taeniolite.

6. The barrier film of claim 4, wherein the clay comprises vermiculite,

7. The barrier film of claim 1, wherein the first coating resides between the second coating and the substrate.

8. The barrier film of claim 1, wherein a primer coating is between the first coating and the second coating.

9. The barrier film of claim 8, wherein the primer coating is derived from a water-based polyurethane emulsion.

10. The barrier film of claim 1, wherein the polyhydroxylic polymer comprises polyvinyl alcohol.

11. The barrier film of claim 1, wherein the substrate comprises polyethylene terephthalate (PET), glycolised polyester (PET-G), nylon, biaxially oriented polypropylene (BOPP), oriented polypropylene, cast polypropylene, polystyrene, polyethylene (PE), polyvinyl chloride, polylactic acid (PLA), polyhydroxyalkanoate (PHA), biaxially oriented PET, biaxially oriented PETG, biaxially oriented nylon (BON), biaxially oriented polyethylene, biaxially oriented PLA, biaxially oriented PHA, polyvinylidene chloride (PVDC), ethylene vinyl acetate (EVA), PEEK and fluorinated olefins.

12. The barrier film of claim 1, wherein the barrier film exhibits a change in oxygen transmission rate of less than 1 cc/100 in² after flexing according to ASTM F392 followed by measurement of oxygen permeation at 0% relative humidity.

13. The barrier film of claim 1, wherein the substrate comprises polyester.

14. The barrier film of claim 1, wherein the metal oxide comprises an aluminum oxide.

15. The barrier film of claim 1, wherein the metallic coating comprises aluminum.

16. The barrier film of claim 1, wherein the inorganic oxide comprises an oxide of silicon.

17. A method of forming a barrier film comprising depositing a first coating and a second coating onto a substrate, wherein
the first coating comprising an inorganic oxide, metal oxide or metallic coating; and
the second coating comprising a polyhydroxylic polymer or a urethane-containing polymer.

18. The method of claim 17, wherein the second coating additionally comprises
(a) clay, and
(b) chemical stabilizing agent, wherein the chemical stabilizing agent comprises one or more of:
materials that contain cationic functionality comprising at least one of lithium, alkyl C₂-C₆ ammonium, allyl ammonium, heterocylclic ammonium, morpholonium, ammonium and amino C₃-C₆ alkyl carboxylic acids;
lithium cations in combination with anions comprising at least one of carboxylic, phosphoric, phosphonic, sulfonic and fatty acids, lithium chelating agents, and lithium salts; and
ammonia, C₃-C₆ amine, heterocyclic amines, lithium hydroxide, morpholine, and morpholine oleate.

19. The method of claim 17, wherein the clay comprises vermiculite,

20. The method of claim 17, wherein the first coating resides between the second coating and the substrate.

21. The method of claim 17, wherein the metal oxide comprises an aluminum oxide.

22. An article comprising a barrier film of claim 1.
